(19) United States
(12) Patent Application Publication
(10) Pub. No.: US 2026/0188717 A1
(43) Pub. Date: Jul. 2, 2026

(54) SUPPORT PUSHING SYSTEM AND SUPPORT PUSHING METHOD

(71) Applicant: QUJING EVE ENERGY CO., LTD., Qujing (CN)

(72) Inventors: Shilin KUAI, Qujing (CN); Pengchong DING, Qujing (CN); Wenjun WU, Qujing (CN); Heng LI, Qujing (CN); Jincheng LIU, Qujing (CN)

(73) Assignee: QUJING EVE ENERGY CO., LTD., Qujing (CN)

(21) Appl. No.: 19/304,557

(22) Filed: Aug. 19, 2025

Related U.S. Application Data
(63) Continuation of application No. PCT/CN2025/089246, filed on Apr. 16, 2025.

(30) Foreign Application Priority Data
Dec. 31, 2024 (CN) 202411988533.5

(51) Int. Cl. H01M 10/04

(52) U.S. Cl. CPC H01M 10/04

(57) ABSTRACT

A support pushing system and a support pushing method are provided in the present application. The support pushing system includes: a pushing device; an opening-closing device provided at a side of the pushing device; and a moving device connected with the opening-closing device or the winding core.

### CROSS-REFERENCE TO RELATED APPLICATION

This application is a Bypass Continuation Application of PCT/CN2025/089246 filed on Apr. 16, 2025, which claims priority to Chinese Patent Application No. 2024119885335, filed on Dec. 31, 2024, the disclosure of which is incorporated herein by reference in its entirety.

### TECHNICAL FIELD

The present application relates to the technical field of batteries, and more particularly, to a support pushing system and a support pushing method.

### BACKGROUND

For the battery cell formed by winding, after the winding needle is taken out, a central hole is formed in the interior of the winding core. During subsequent manufacturing and recycling of the battery, because the gap is in the central hole, the winding core may be deformed, and the central area is prone to collapse and deformation or even breakage, which affects normal use of the battery.

In order to improve the above-mentioned disadvantages, in the related art, it is a general practice to insert a support at the central hole of the winding core to support the interior of the winding core, so as to prevent the center of the winding core from collapsing and deforming. At the same time, in order to ensure that the support can abut against the wall of the central hole of the winding core, the external dimension of the support needs to be very close to the dimension of the central hole of the winding core.

### SUMMARY

Due to objective factors such as processing and manufacturing errors of the supports, processing and manufacturing tolerances of some of the supports are beyond the range, and the consistency of the supports is lower, thereby resulting in difficulty in inserting the support into the central hole. Alternatively, when the support is forcibly inserted into the central hole, the diaphragm and the electrode are easily damaged, thereby causing the winding core to be scrapped.

In a first aspect, the present application provides a support pushing system for pushing each of one or more supports toward a central hole of a corresponding winding core, the support pushing system including:
a pushing device for pushing the support into the central hole of the winding core;
an opening-closing device provided on a side of the pushing device, wherein the opening-closing device comprises an opening-closing drive mechanism and a plurality of opening-closing pieces, the opening-closing device is configured for driving the plurality of opening-closing pieces to open to form or close a pushing opening, such that the pushing device drives the support pass through the pushing opening when the pushing opening is formed, so as to enable the support to enter the central hole, wherein the plurality of the opening-closing pieces are formed to be a tapered shape in a closed state, and a tip of the tapered shape faces toward the central hole of the winding core; and
a moving device connected to the opening-closing device or the winding core, such that the opening-closing device or the winding core is driven to relatively move in a pushing direction of the pushing device, so as to enable the opening-closing device and the winding core to be close to or far away from each other.

In a second aspect, according to the present application, it is further provided a support pushing method comprising steps of:
driving an opening-closing device by a moving device to move toward a winding core, or driving the winding core by the moving device to move toward the opening-closing device, such that a plurality of opening-closing pieces in a closed state are inserted into a central hole of the winding core;
driving the plurality of opening-closing pieces by an opening-closing drive mechanism to open to form a pushing opening;
pushing each of one or more supports by a pushing device to pass through the pushing opening and into the central hole;
driving the opening-closing device by the moving device to move in a direction away from the winding core, or driving the winding core by the moving device to move in a direction away from the opening-closing device; and
driving the plurality of opening-closing pieces by the opening-closing drive mechanism to close to form a tip.

### BENEFICIAL EFFECT

When the support is pushed into the winding core, the opening-closing device and the winding core are moved close to or away from each other via the moving device. When the opening-closing device and the winding core are close to each other, the tip of the plurality of opening-closing pieces that are formed to be a tapered shape in the closed state can be conveniently inserted into the end of the central hole, and then the plurality of opening-closing pieces are driven to open by the opening-closing drive mechanism to form a pushing opening. At this time, the pushing device is convenient to push the support through the pushing opening and into the winding core. Since the plurality of opening-closing pieces are opened again from the closed state where the opening-closing pieces are formed to be the tapered shape, and the tapered shape has a smaller outer diameter and a guiding function, the opening-closing pieces can be easily inserted into the central hole of the winding core, thereby avoiding damage to the winding core. Further, the support can rapidly enter quickly into the winding core under the guiding function of the opening-closing pieces, thereby improving the production efficiency.

### BRIEF DESCRIPTION OF THE DRAWINGS

FIG. 1 is a schematic structural diagram of a support pushing system according to embodiments of the present application;

FIG. 2 is a schematic diagram of a pushing process of the support pushing system of FIG. 1; and

FIG. 3 is a schematic diagram of an angle between an opening-closing piece and a pushing direction in FIG. 2.

In figures: 100-support pushing system, 10-pushing device, 20-opening-closing device, 22-opening-closing piece, 23-pushing opening, 24-tip, 30-moving device, 40-guide, 41-hole portion, 50-feeding device, 310-jacking mechanism, 511-pushing inclined surface, 52-stock bin, 521-inclined wall, 522-vertical wall, 523-bottom wall, 60-supporting table, 61-profiling groove, 70-guiding table, 80-position detection device, 200-support, 300-winding core, 310-central hole.

### DETAILED DESCRIPTION

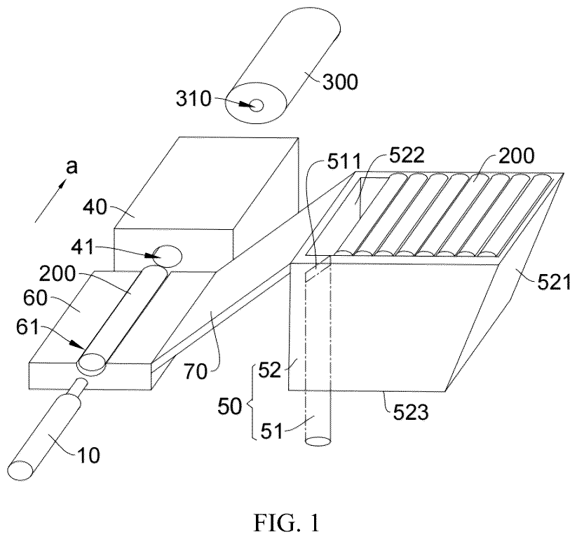

Referring to FIG. 1 to FIG. 3, a support pushing system 100 is provided. The support pushing system 100 is used for pushing a support 200 to a central hole 310 of a winding core 300. The support pushing system 100 includes a pushing device 10, an opening-closing device 20, and a moving device 30.

In some embodiments, the pushing device 10 is used to push the support 200 into the central bore 310 of the winding core 300. The opening-closing device 20 is provided at a side of the pushing device 10, and includes an opening-closing drive mechanism (not shown) and multiple opening-closing pieces 22. The pushing device 10 is used for driving the opening-closing pieces 22 to open to form a pushing opening 23 or to close a pushing opening 23, so as to drive the support 200 by the pushing device 10 to penetrate through the pushing opening 23 when the pushing opening 23 is formed, so that the support 200 enters into the central hole 310. In some embodiments, the opening-closing pieces 22 are formed to be a tapered shape in a closed state, and a tip 24 of the tapered shape faces towards the winding core 300. The moving device 30 is connected to the opening-closing device 20 or the winding core 300 so as to be able to drive the opening-closing device 20 or the winding core 300 to relatively move in a pushing direction a of the support 200, so as to enable the pushing device 10 and the winding core 300 to be close to or far away from each other.

In the support pushing system 100, when the support 200 is pushed into the winding core 300, the opening-closing device 20 and the winding core 300 are brought close to or away from each other by the moving device 30. When the opening-closing device 20 and the winding core 300 are brought close to each other, the tip 24 of the opening-closing pieces 22 that are formed to be the tapered-shape in the closed state can be conveniently inserted into an end of the central hole 310. Then, the plurality of opening-closing pieces 22 are driven by the opening-closing drive mechanism to open to form a pushing opening 23. In this case, the pushing device 10 pushes the support 200 through the pushing opening 23 and then into the winding core 300. The plurality of opening-closing pieces 22 are opened again from the closed state in which the opening-closing pieces 22 are formed to be the tapered shape, and the tapered shape has a small outer diameter and has a guiding function. In this way, the support 200 can be easily inserted into the central hole 310 of the winding core 300, thereby avoiding damage to the winding core 300. At the same time, under the guidance of the opening-closing pieces 22, the support 200 can rapidly enter into the winding core 300, thereby improving the production efficiency.

In some embodiments, the support 200 is pushed into the cylindrical winding core 300, and the support 200 is also cylindrical. In some embodiments, the shape of the support may be provided in accordance with the shape of the winding core. For example, when the winding core is square, the support may be provided in a square shape.

In some embodiments, when the support 200 is to be pushed, the pushing device 10 may be provided as a cylinder, and a clamping jaw may be provided on a piston shaft of the cylinder. The clamping jaw may be capable of holding the support. When the opening-closing device 20 is in an open state to form the pushing opening 23, the cylinder may be capable of driving the support 200 through the pushing opening 23 and into the central hole 310 of the winding core 300. In another embodiment, the pushing device 10 may be provided as a drive motor, a lead screw, a movable block, and a clamping jaw. The lead screw is connected to the drive motor, the movable block and the lead screw are rotatably arranged, and the clamping jaw is connected to the movable block and is used to hold the support 200. So, the support 200 is pushed into the winding core 300 after the clamping jaw clamps the support 200 to pass through the pushing opening 23 under the drive of the motor.

In some embodiments, when the opening-closing device 20 is provided, the opening-closing drive mechanism may be provided as an opening-closing cylinder on which two half-cone-shaped opening-closing pieces 22 oppositely arranged are provided. The opening and closing operations between the two half-cone-shaped opening-closing pieces 22 are realized under the driving of the opening-closing cylinder. In some embodiments, multiple opening-closing pieces 22 are provided. For example, the opening and closing operations among the multiple opening-closing pieces 22 can be realized in a manner of opening and closing the umbrella frame driven by a connecting rod in Publication No. CN116088250A. Or, in some embodiments, the opening and closing operations among the multiple opening-closing pieces 22 can be realized in a manner of opening and closing the apertures by the gear fitting in Publication No. CN215705880U. The selection of the opening-closing drive mechanism is not limited thereto.

It will be appreciated that in some embodiments, the plurality of opening-closing pieces 22 may be provided as at least two pieces, or may be three pieces, four pieces or five pieces or more, which is not limited herein, as long as the opening-closing pieces 22 can be opened and closed in accordance with the structure of the opening-closing drive mechanism.

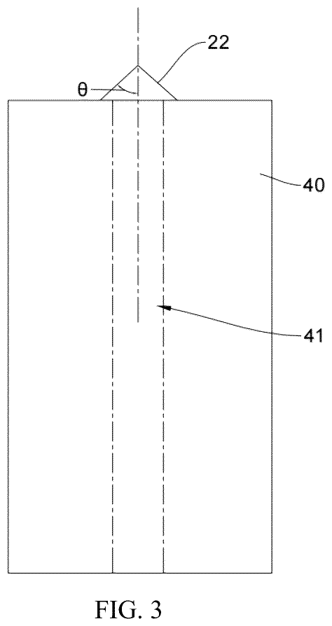

In some embodiments, referring to FIG. 3, when the plurality of opening-closing pieces 22 are in the closed state, there is an included angle θ between each opening-closing piece 22 and the pushing direction a. The included angle θ is an acute angle, and the included angle θ ranges from 20°to 80°. By the arrangement of the included angle θ, when the plurality of opening-closing pieces 22 are switched from the closed state to the open state, it can ensure the size of the diameter of the pushing opening 23 formed by opening the opening-closing pieces 22. If the included angle is set to be less than 20°, the diameter of the pushing opening 23 formed by opening the opening-closing pieces 22 may not be large enough to match the diameter of the support. When the included angle is set to be greater than 80 degrees, under the opening-closing piece 22 in the open state, the guiding effect on the support 200 is reduced. By setting the included angle θ in the range of 20°-80°, not only the diameter of the support 200 can be taken into account, but also the movement of the support 200 can be guided, so as to avoid excessive deviation from the central hole 310 of the winding core 300 when the support 200 moves away from the pushing opening 23.

In some embodiments, the included angle θ may be set to a value of 20°, 30°, 40°, 50°, 60°, 70°, or 80°, and the like, and is not limited herein.

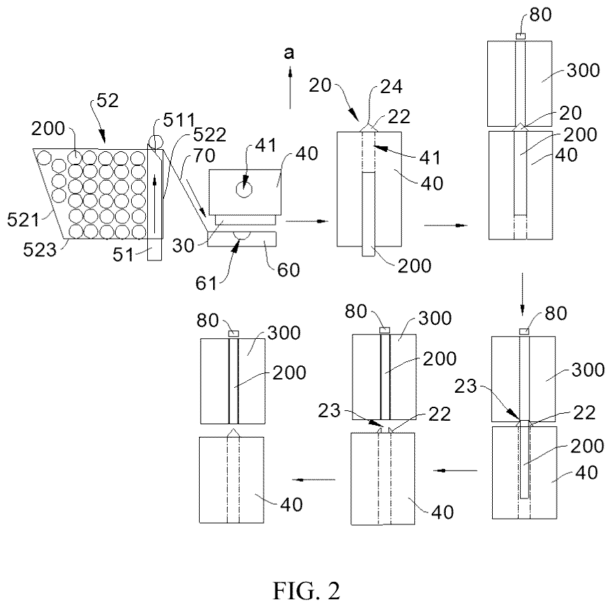

Referring to FIGS. 1 and 2, in some embodiments, in order to ensure that the central axis of the central hole 310 of the winding core 300 is aligned when the support 200 is pushed by the pushing device 10, the support pushing system 100 further includes a guide 40. The opening-closing device 20 is connected to the guide 40. The opening-closing device 20 and the pushing device 10 are located at opposite two sides of the guide 40 in the pushing direction a. The guide 40 has a hole portion 41. The central axis of the hole portion 41, the central axis of the pushing opening 23, and the central axis of the central hole 310 of the winding core 300 are coincided. The pushing device 10 pushes the support 200 through the hole portion 41 and the pushing opening 23 in turn. In this way, the guide 40 is provided between the pushing device 10 and the winding core 300, so that during the pushing device 10 drives the support 200 to move in a direction toward the winding core 300, the support 200 passes through the hole portion 41 of the guide 40 firstly, and then is pushed into the central hole 310 of the winding core 300 after being corrected by the guide 40, so as to ensure accuracy in inserting the support 200.

In some embodiments, the hole portion 41 is provided as a full hole. The hole portion 41 is provided in a central region of the guide 40, and extended through the guide 40 in the pushing direction a.

In some embodiments, the moving device 30, when provided, may be connected to the opening-closing device 20 or to a supporting device supporting the winding core 300. A driving movement direction of the moving device 30 is parallel to the pushing direction a of the pushing device 10, so as to drive the opening-closing device 20 and the winding core 300 to be close to or far away from each other. So, the tip 24 of the tapered shape of the opening-closing device 20 can extend into the winding core 300 when the opening-closing device 20 and the winding core 300 are in proximity, thus it can ensure that the opening-closing device 20 and the winding core 300 are far away from each other after the support 200 is pushed into the central hole 310.

In some embodiments, the moving device 30 may be provided as a linear module to enable driving in the linear direction. In some embodiments, since the opening-closing device 20 is connected to the guide 40, when the linear module is connected to the opening-closing device 20, the linear module is provided at the bottom of the guide 40 to synchronously drive the movements of both the guide 40 and the opening-closing device 20 in the pushing direction a.

Referring to FIGS. 1 and 2, in some embodiments, in order to enable the orderly provision of the supports 200 to the pushing device 10, the support pushing system 100 includes a feeding device 50 for placing the supports 200 and pushing out the supports 200 one by one. By arranging the feeding device 50, the supports 200 can be provided orderly and one by one to the pushing device 1, thereby ensuring the connection of the production cycle time.

In some embodiments, in order to receive the supports 200 delivered from the feeding device 50, the support pushing system 100 further includes a supporting table 60. The supporting table 60 is provided in the pushing direction a of the pushing device 10. The supporting table 60 is located in front of the opening-closing device 20 in the pushing direction a for supporting the supports 200 supplied from the feeding device 50. Since the feeding device 50 is used for placing the supports 200 and pushing out the supports 200 to the supporting table 60 one by one, and the supporting table 60 is provided in the pushing direction of the pushing device 10, the supporting table 60 supports the supports 200 conveyed from the feeding device 50, and the pushing device 10 pushes the supports 200 on the supporting table 60 through the opening-closing device 20 and finally into the winding core 300. By the supporting of the supporting table 60, the placing direction of the support 200 can be preliminarily positioned.

In some embodiments, in order to facilitate placement of the support 200, the supporting table 60 is provided with a profiling groove 61. A shape of the profiling groove 61 is matched with a shape of the support 200 so as to limit placement of the support 200.

In some embodiments, on the basis of the provision of the guide 40, in some embodiments, the supporting table 60 is provided, and in the push direction a, the pushing device 10, the supporting table 60, the guide 40, and the opening-closing device 20 are provided in sequence. The pushing device 10 pushes the support 200 on the supporting table 60 through the guide 40. And, the support 200 is preliminarily corrected by the guide 40, and enters into the central hole 310 of the winding core 300 after passing through the pushing opening 23 of the opening-closing device 20.

In some embodiments, the feeding device 50 may be arranged in such a manner that the feeding direction of the feeding device 50 is perpendicular to the pushing direction a of the pushing device 10. The feeding device 50 may also be provided as the drive cylinder, and the piston shaft of the cylinder is extended to push the supports 200 placed on the supporting plane to the supporting table 60 one by one. In some embodiments, the feeding device 50 may be in the form of a motor, a lead screw, and a push rod. The rotation of the motor drives the lead screw to rotate, and the rotation of the lead screw drives the push rod to push the support 200 toward the supporting table 60.

In some embodiments, referring to FIGS. 1 and 2, in order to ensure the production cycle time, the feeding device 50 includes a jacking mechanism 51 and a stock bin 52. The jacking mechanism 51 is provided at a bottom of the stock bin 52 for ejecting the supports 200 in the stock bin 52 one by one in an upward manner. Thus, after the supports 200 are pushed into the winding core 300 one by one by the pushing device 10, the jacking mechanism 51 synchronously pushes the supports 200 to the supporting table 60 one by one, and the production cycle time is sequentially connected to ensure the production efficiency.

In some embodiments, the jacking mechanism 51, when provided, may be provided as a drive cylinder, and the jacking mechanism 51 is provided in a vertical direction. Thus, the supports 200 are pushed out of the stock bin 52 and moved to the supporting table 60 as the piston shaft of the drive cylinder expands. In some embodiments, the jacking mechanism 51 may be provided as a mechanism capable of realizing linear driving when the motor and the lead screw are engaged.

In some embodiments, when the stock bin 52 is provided, the stock bin 52 includes an inclined wall 521 and a vertical wall 522 relatively disposed. The inclined wall 521 is disposed obliquely downward. The jacking mechanism 51 is disposed adjacent to the vertical wall 522 for pushing the supports 200 upwardly along the wall of the vertical wall 522 one by one. Under providing the inclined wall 521, as the supports 200 are pushed out one by one by the jacking mechanism 51, the support 200 is capable of moving downwardly by gravity itself, and moving one by one towards the vertical wall 522 to locate above the jacking mechanism 51; then the jacking mechanism 51 gradually jacks the support 200 along the vertical wall 522, and the support 200 is finally rolled out of an opening of the stock bin 52.

In some embodiments, the jacking mechanism 51 is disposed at the bottom wall 523 of the stock bin 52, and the piston shaft of the jacking mechanism 51 can penetrate through the bottom wall 523 to jack the support 200.

In some embodiments, the jacking mechanism 51 includes a pushing inclined surface 511, such as a pushing block having a pushing inclined surface 511 at the end of the piston shaft. So, when the jacking mechanism 51 jacks the support 200 to the opening of the stock bin 52, the pushing inclined surface 511 has a guiding effect on the support 200, and the support can move out of the stock bin 52 in the inclined direction of the pushing inclined surface 511. It will be appreciated that in some embodiments there is an included angle between the pushing included surface 511 and the vertical wall 522. The included angle is an acute angle.

Referring to FIG. 1 and FIG. 2, in some embodiments, since the stock bin 52 has a certain height to accommodate the supports 200. In order to facilitate the connection between the support 200 and the supporting table 60 when the support 200 is pushed out of the stock bin 52, the support pushing system 100 further includes a guiding table 70 obliquely and downwardly disposed from an open end of the stock bin 52 and engaged with the supporting table 60 for sliding the support 200 pushed out by the jacking mechanism 51 to the supporting table 60. So, the support 200, after being moved out of the stock bin 52, can slide to the supporting table 60 along the guiding table 70 obliquely and downwardly disposed through the provision of the guiding table 70, thereby ensuring the stability of the movement of the support 200, avoiding the occurrence of disorderly rolling, and enabling the connection of the production line.

In some embodiments, referring to FIG. 2, in order to detect the pushed position of the support 200 within the winding core 300, the support pushing system 100 further includes a position detection device 80. The position detection device 80 and the pushing device 10 are disposed at opposite two sides of the winding core 300 in the pushing direction a so as to detect the position of the support 200 within the winding core 300. In this way, by the arrangement of the position detection device 80, it can avoid a case where the support 200 is pushed beyond the position and thus exposes the winding core 300.

In some embodiments, the position detection device 80 may be provided as a baffle plate indicating that the support 200 is pushed in place when the support 200 is pushed to be in contact with the baffle plate. Alternatively, the position detection device 80 may be provided as a distance sensor. The pushed-in position of the support 200 is accurately detected by the distance sensor.

Referring to FIG. 2, the support pushing system 100 of the present embodiment operates as follows:
(a) the supports 200 are temporarily stored by the stock bin 52 and pushed out one by one by the jacking mechanism 51; and each of the supports 200 separated from the stock bin 52 rolls along the guiding table 70 and onto the supporting table 60 to be received by the supporting table 60;
(b) the moving device 30 drives the guide 40 and the opening-closing device 20 to move towards the winding core 300, the tip formed by the plurality of opening-closing pieces 22 is inserted into the central hole 310 of the winding core 300, and the support 200 is moved along the guide 40 by the pushing device 10;
(c) the opening-closing mechanism drives the opening-closing pieces 22 to open to form a pushing opening 23, and the pushing device 10 pushes the support 200 through the pushing opening 23 and into the winding core 300; and
(d) upon completion of sequentially inserting the supports 200, the moving device 30 drives both the guide 40 and the opening-closing device 20 back to the original positions thereof, and the opening-closing pieces 22 are closed.

In view of the foregoing, the support pushing system 100 has the following advantages:
(1) by the guiding effect of the opening-closing pieces 22, the support 200 can be smoothly pushed into the winding core 300, so that it can avoid the damage to the winding core 300 caused by forcedly pushing the support 200;
(2) the pushing system of the present embodiments can synchronize with the operation of other processes of the equipment when the pushing operation is performed, thereby solving the problem that the production cycle time needs to be reserved separately;
(3) the support 200 can be pushed when a temperature of the support 200 is a normal temperature, thereby avoiding a quality problem such as a short circuit of the battery cell caused by enabling the high temperature of the support 200 to form a perforating hole in the prior art;
(4) the accuracy and the efficiency of the insertion of the support 200 into the central hole 310 is improved, thereby greatly improving the process yield and the product quality, and thus increasing the capacity of the equipment.

In another embodiment, the present application also provides a support pushing method comprising the steps of:
at step S21, a moving device 30 drives an opening-closing device 20 to move toward a winding core 300, or drives the winding core 300 to move toward the opening-closing device 20, so that a plurality of opening-closing pieces 22 in a closed state are inserted into a central hole 310 of the winding core 300;
at step S22, an opening-closing drive mechanism drives the plurality of opening-closing pieces 22 to open to form a pushing opening 23;
at step S23, the pushing device 10 pushes the support 200 through the pushing opening 23 and into the central hole 310;
at step S24, the moving device 30 drives the opening-closing device 20 to move in a direction away from the winding core 300, or drives the winding core 300 to move in a direction away from the opening-closing device 20; and
at step S25, the opening-closing drive mechanism drives the plurality of opening-closing pieces 22 to close to form a tip.

According to the pushing method for one or more supports 200, the plurality of the opening-closing pieces 22 are formed to be a tapered shape when the plurality of the opening-closing pieces 22 are in the closed state, so that the support 200 can be smoothly inserted into the winding core 300; and then the plurality of the opening-closing pieces 22 are opened to form a pushing opening 23, so that the pushing of the support 200 can be guided, thereby improving the insertion efficiency of the support 200 and avoiding damage to the winding core 300.

What is claimed is:

1. A support pushing system, the pushing system being configured for pushing each of one or more supports toward a central hole of a corresponding winding core, the support pushing system comprising:
a pushing device for pushing the support into the central hole of the winding core;
an opening-closing device provided at a side of the pushing device, wherein the opening-closing device comprises an opening-closing drive mechanism and a plurality of opening-closing pieces, the opening-closing device is configured for driving the plurality of opening-closing pieces to open to form or close a pushing opening, such that the pushing device drives the support pass through the pushing opening when the pushing opening is formed, so as to enable the support to enter the central hole, wherein the plurality of the opening-closing pieces are formed to be a tapered shape in a closed state, and a tip of the tapered shape faces toward the central hole of the winding core; and
a moving device connected to the opening-closing device or the winding core, such that the opening-closing device or the winding core is driven to relatively move in a pushing direction of the pushing device, so as to enable the opening-closing device and the winding core to be close to or far away from each other.

2. The support pushing system according to claim 1, wherein the support pushing system further comprises a guide, the opening-closing device is connected with the guide, and the opening-closing device and the pushing device are located at opposite two sides of the guide in the pushing direction, the guide comprises a hole portion, and a central axis of the hole portion, a central axis of the pushing opening and a central axis of the central hole of the winding core are coincided with each other.

3. The support pushing system according to claim 2, wherein the hole portion is a full hole, and the hole portion is disposed at a central area of the guide, and extended through the guide in the pushing direction.

4. The support pushing system according to claim 1, wherein
the support pushing system comprises a feeding device for placing the one or more supports and pushing the one or more supports out of the feeding device one by one.

5. The support pushing system according to claim 2, wherein
the support pushing system comprises a feeding device for placing the one or more supports and pushing the one or more supports out of the feeding device one by one.

6. The support pushing system according to claim 4, wherein the support pushing system further comprises a supporting table;
the supporting table is provided in the pushing direction of the pushing device, and is located in front of the guide in the pushing direction for supporting the support conveyed by the feeding device.

7. The support pushing system according to claim 6, wherein the supporting table comprises a profiling groove, and a shape of the profiling groove is matched with a shape of the support.

8. The support pushing system according to claim 7, wherein the profiling groove is of a recessed structure that is recessed from a top surface of the supporting table, and the profiling groove is extended through the supporting table in the pushing direction at a center of the supporting table.

9. The support pushing system according to claim 4, wherein
the feeding device comprises a jacking mechanism and a stock bin, the jacking mechanism is provided at a bottom of the stock bin, the stock bin comprises a inclined wall and a vertical wall oppositely arranged, the inclined wall is disposed obliquely downwardly, and the jacking mechanism is disposed adjacent to the vertical wall for pushing the supports one by one upwardly along a surface of the vertical wall to separate from the stock bin.

10. The support pushing system according to claim 9, wherein the jacking mechanism comprises a pushing inclined surface arranged obliquely downward with respect to the vertical wall.

11. The support pushing system according to claim 10, wherein an included angle is between the pushing inclined surface and the vertical wall, and the included angle is an acute angle.

12. The support pushing system according to claim 9, the vertical wall is more adjacent to the pushing device than the included wall.

13. The support pushing system according to claim 6, wherein the support pushing system further comprises a guiding table arranged obliquely downward from an open end of the stock bin, and the guiding table is engaged with the supporting table for sliding the support pushed out by the jacking mechanism to the supporting table.

14. The support pushing system according to claim 7, wherein the support pushing system further comprises a guiding table arranged obliquely downward from an open end of the stock bin, and the guiding table is engaged with the supporting table for sliding the support pushed out by the jacking mechanism to the supporting table.

15. The support pushing system according to claim 8, wherein the support pushing system further comprises a guiding table arranged obliquely downward from an open end of the stock bin, and the guiding table is engaged with the supporting table for sliding the support pushed out by the jacking mechanism to the supporting table.

16. The support pushing system according to claim 1, wherein when the plurality of the opening-closing pieces are in the closed state, an included angle is between each of the opening-closing pieces and the pushing direction, the included angle is an acute angle, and the included angle ranges from 20°to 80°.

17. The support pushing system according to claim 2, wherein when the plurality of the opening-closing pieces are in the closed state, an included angle is between each of the opening-closing pieces and the pushing direction, the included angle is an acute angle, and the included angle ranges from 20°to 80°.

18. The support pushing system according to claim 1, wherein the support pushing system further comprises a position detection device, the position detection device and the pushing device are provided at opposite two sides of the winding core in the pushing direction, and the position detection device is configured for detecting a pushed position of the support in the winding core.

19. The support pushing system according to claim 2, wherein the support pushing system further comprises a position detection device, the position detection device and the pushing device are provided at opposite two sides of the winding core in the pushing direction, and the position detection device is configured for detecting a pushed position of the support in the winding core.

20. A support pushing method comprising:
driving an opening-closing device by a moving device to move toward a winding core, or driving the winding core by the moving device to move toward the opening-closing device, such that a plurality of opening-closing pieces in a closed state are inserted into a central hole of the winding core;
driving the plurality of opening-closing pieces by an opening-closing drive mechanism to open to form a pushing opening;
pushing each of one or more supports by a pushing device to pass through the pushing opening and into the central hole;
driving the opening-closing device by the moving device to move in a direction away from the winding core, or driving the winding core by the moving device to move in a direction away from the opening-closing device; and
driving the plurality of opening-closing pieces by the opening-closing drive mechanism to close to form a tip.
